(19) United States
(12) Patent Application Publication
(10) Pub. No.: US 2015/0127582 A1
(43) Pub. Date: May 7, 2015

(54) SYSTEM, METHOD, AND COMPUTER READABLE MEDIUM FOR CALCULATING MIXED FREQUENCY VALUATION CHANGES OF ILLIQUID ASSETS

(71) Applicant: Pantheon Ventures (UK) LLP, London (GB)

(72) Inventors: Chris Stanley Meads, Sai Kung (New Territories) (HK); Andres Reibel, London (GB)

(21) Appl. No.: 14/532,416

(22) Filed: Nov. 4, 2014

Related U.S. Application Data
(60) Provisional application No. 61/899,551, filed on Nov. 4, 2013.
(60) Provisional application No. 61/901,652, filed on Nov. 8, 2013.

(51) Int. Cl. G06Q 40/06

(52) U.S. Cl. CPC G06Q 40/06
USPC 705/36 R

(57) ABSTRACT

Methods and systems for determining mixed frequency valuations and valuation changes for illiquid assets.

### CROSS REFERENCE TO RELATED APPLICATIONS

This application claims priority to U.S. Provisional Patent Application No. 61/899,551 filed Nov. 4, 2013 and U.S. Provisional Patent Application No. 61/901,652 filed Nov. 8, 2013, each of which are incorporated by reference herein for all purposes in their entireties.

### FIELD OF THE DISCLOSURE

The present disclosure relates to systems, methods, and computer readable medium for determining mixed frequency, e.g., daily, weekly, or monthly, valuations and valuation changes of illiquid assets, e.g., certain private equity investments.

### BACKGROUND INFORMATION

Many asset classes, such as bonds and public equities, provide daily pricing. However, in the private equity market, price changes in a private equity company's holdings are generally calculated quarterly. It would be beneficial to estimate higher frequency valuation changes, e.g., daily, weekly, or monthly valuation changes, for private equity company holdings. This invention addresses this problem.

### SUMMARY

In one embodiment, disclosed herein is a system including: memory operable to store at least one program; at least one processor communicatively coupled to the memory, in which the at least one program, when executed by the at least one processor, causes the at least one processor to: receive data describing a first group of one or more portfolio companies and a second group of one or more portfolio companies; attribute industry sector classifications to each portfolio company of the first group of one or more portfolio companies and to each portfolio company of the second group of one or more portfolio companies; receive industry sector total return index data for the industry sector classifications attributed to each portfolio company of the first group of one or more portfolio companies and to each portfolio company of the second group of one or more portfolio companies; receive lagged valuation change data for each portfolio company of the first group of one or more portfolio companies and for each portfolio company of the second group of one or more portfolio companies; estimate the relationship between a valuation change, the industry sector total return index data for the industry sector classifications attributed to each portfolio company of the first group of one or more portfolio companies and the lagged valuation change data for each portfolio company of the first group of one or more portfolio companies; and calculate a daily valuation change for each portfolio company of the second group of one or more portfolio companies using the estimated relationship between the valuation change, the industry sector total return index data for the industry sector classifications attributed to each portfolio company of the first group of one or more portfolio companies and the lagged valuation change data for each portfolio company of the first group of one or more portfolio companies.

In an embodiment, also disclosed herein, the system is further configured to: aggregate one or more high frequency macroeconomic variables for each portfolio company of the first group of one or more portfolio companies and for each portfolio company of the second group of one or more portfolio companies; estimate the relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies; and calculate one or more high-frequency valuation changes for each portfolio company of the second group of one or more portfolio companies using the estimated relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies.

In one embodiment, the one or more high frequency macroeconomic variables include U.S. unemployment insurance. In another embodiment, the one or more high-frequency valuation changes include a weekly valuation change. In some embodiments, the one or more high frequency macroeconomic variables includes U.S. unemployment insurance and U.S. factory orders.

In certain embodiments, the one or more high-frequency valuation changes include a monthly valuation change. In other embodiments, the one or more high-frequency valuation changes include a weekly valuation change and a monthly valuation change.

In one embodiment, disclosed herein is a system including: memory operable to store at least one program; at least one processor communicatively coupled to the memory, in which the at least one program, when executed by the at least one processor, causes the at least one processor to: receive data describing a first group of one or more portfolio companies and a second group of one or more portfolio companies; attribute industry sector classifications to each portfolio company of the first group of one or more portfolio companies; receive industry sector total return index data for the industry sector classifications attributed to each portfolio company of the first group of one or more portfolio companies; receive lagged valuation change data for each portfolio company of the first group of one or more portfolio companies; estimate the relationship between a valuation change, the industry sector total return index data for the industry sector classifications attributed to each portfolio company of the first group of one or more portfolio companies and the lagged valuation change data for each portfolio company of the first group of one or more portfolio companies; for each portfolio company of the second group of one or more portfolio companies, determine whether each portfolio company of the second group of one or more portfolio companies is a publicly listed portfolio company or a non-publicly listed portfolio company; receive daily market valuation change data for each publicly listed portfolio company; for each non-publicly listed company: attribute industry sector classifications to each non-publicly listed company; receive industry sector total return index data for each non-publicly listed company; receive lagged valuation change data for each non-publicly listed company; and for each non-publicly listed company, calculate a daily valuation change for each non-publicly listed company using the estimated relationship between the valuation change, the industry sector total return index data for the industry sector classifications attributed to each portfolio company of the first group of one or more portfolio companies and the lagged valuation change data for each portfolio company of the first group of one or more portfolio companies; and calculate a total valuation change for the second group of one or more portfolio companies using the daily market valuation change data for each publicly listed portfolio company and the daily valuation change for each non-publicly listed company.

In one embodiment, disclosed herein, is a non-transitory computer readable storage medium having stored thereon computer executable instructions which, when executed on a computer, configure the computer to perform a method comprising: receiving data describing a first group of one or more portfolio companies and a second group of one or more portfolio companies; attributing industry sector classifications to each portfolio company of the first group of one or more portfolio companies and to each portfolio company of the second group of one or more portfolio companies; receiving industry sector total return index data for the industry sector classifications attributed to each portfolio company of the first group of one or more portfolio companies and to each portfolio company of the second group of one or more portfolio companies; receiving lagged valuation change data for each portfolio company of the first group of one or more portfolio companies and for each portfolio company of the second group of one or more portfolio companies; estimating the relationship between a valuation change, the industry sector total return index data for the industry sector classifications attributed to each portfolio company of the first group of one or more portfolio companies and the lagged valuation change data for each portfolio company of the first group of one or more portfolio companies; and calculating a daily valuation change for each portfolio company of the second group of one or more portfolio companies using the estimated relationship between the valuation change, the industry sector total return index data for the industry sector classifications attributed to each portfolio company of the first group of one or more portfolio companies and the lagged valuation change data for each portfolio company of the first group of one or more portfolio companies.

In an embodiment, disclosed herein, the non-transitory computer readable storage medium further includes aggregating one or more high frequency macroeconomic variables for each portfolio company of the first group of one or more portfolio companies and for each portfolio company of the second group of one or more portfolio companies; estimating the relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies; and calculating one or more high-frequency valuation changes for each portfolio company of the second group of one or more portfolio companies using the estimated relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies.

In one embodiment, disclosed herein, is a non-transitory computer readable storage medium having stored thereon computer executable instructions which, when executed on a computer, configure the computer to perform a method including: receiving data describing a first group of one or more portfolio companies and a second group of one or more portfolio companies; attributing industry sector classifications to each portfolio company of the first group of one or more portfolio companies; receiving industry sector total return index data for the industry sector classifications attributed to each portfolio company of the first group of one or more portfolio companies; receiving lagged valuation change data for each portfolio company of the first group of one or more portfolio companies; estimating the relationship between a valuation change, the industry sector total return index data for the industry sector classifications attributed to each portfolio company of the first group of one or more portfolio companies and the lagged valuation change data for each portfolio company of the first group of one or more portfolio companies; for each portfolio company of the second group of one or more portfolio companies, determining whether each portfolio company of the second group of one or more portfolio companies is a publicly listed portfolio company or a non-publicly listed portfolio company; receiving daily market valuation change data for each publicly listed portfolio company; for each non-publicly listed company: attributing industry sector classifications to each non-publicly listed company; receiving industry sector total return index data for each non-publicly listed company; receiving lagged valuation change data for each non-publicly listed company; and for each non-publicly listed company, calculating a daily valuation change for each non-publicly listed company using the estimated relationship between the valuation change, the industry sector total return index data for the industry sector classifications attributed to each portfolio company of the first group of one or more portfolio companies and the lagged valuation change data for each portfolio company of the first group of one or more portfolio companies; and calculating a total valuation change for the second group of one or more portfolio companies using the daily market valuation change data for each publicly listed portfolio company and the daily valuation change for each non-publicly listed company.

In one embodiment, disclosed herein, is computer implemented method including: receiving data describing a first group of one or more portfolio companies and a second group of one or more portfolio companies; attributing industry sector classifications to each portfolio company of the first group of one or more portfolio companies and to each portfolio company of the second group of one or more portfolio companies; receiving industry sector total return index data for the industry sector classifications attributed to each portfolio company of the first group of one or more portfolio companies and to each portfolio company of the second group of one or more portfolio companies; receiving lagged valuation change data for each portfolio company of the first group of one or more portfolio companies and for each portfolio company of the second group of one or more portfolio companies; estimating the relationship between a valuation change, the industry sector total return index data for the industry sector classifications attributed to each portfolio company of the first group of one or more portfolio companies and the lagged valuation change data for each portfolio company of the first group of one or more portfolio companies; and calculating a daily valuation change for each portfolio company of the second group of one or more portfolio companies using the estimated relationship between the valuation change, the industry sector total return index data for the industry sector classifications attributed to each portfolio company of the first group of one or more portfolio companies and the lagged valuation change data for each portfolio company of the first group of one or more portfolio companies.

In an embodiment, disclosed herein, the computer implemented method further includes aggregating one or more high frequency macroeconomic variables for each portfolio company of the first group of one or more portfolio companies and for each portfolio company of the second group of one or more portfolio companies; estimating the relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies; and calculating one or more high-frequency valuation changes for each portfolio company of the second group of one or more portfolio companies using the estimated relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies.

In one embodiment, disclosed herein, is a computer implemented method including: receiving data describing a first group of one or more portfolio companies and a second group of one or more portfolio companies; attributing industry sector classifications to each portfolio company of the first group of one or more portfolio companies; receiving industry sector total return index data for the industry sector classifications attributed to each portfolio company of the first group of one or more portfolio companies; receiving lagged valuation change data for each portfolio company of the first group of one or more portfolio companies; estimating the relationship between a valuation change, the industry sector total return index data for the industry sector classifications attributed to each portfolio company of the first group of one or more portfolio companies and the lagged valuation change data for each portfolio company of the first group of one or more portfolio companies; for each portfolio company of the second group of one or more portfolio companies, determining whether each portfolio company of the second group of one or more portfolio companies is a publicly listed portfolio company or a non-publicly listed portfolio company; receiving daily market valuation change data for each publicly listed portfolio company; for each non-publicly listed company: attributing industry sector classifications to each non-publicly listed company; receiving industry sector total return index data for each non-publicly listed company; receiving lagged valuation change data for each non-publicly listed company; and for each non-publicly listed company, calculating a daily valuation change for each non-publicly listed company using the estimated relationship between the valuation change, the industry sector total return index data for the industry sector classifications attributed to each portfolio company of the first group of one or more portfolio companies and the lagged valuation change data for each portfolio company of the first group of one or more portfolio companies; and calculating a total valuation change for the second group of one or more portfolio companies using the daily market valuation change data for each publicly listed portfolio company and the daily valuation change for each non-publicly listed company.

### BRIEF DESCRIPTION OF THE DRAWINGS

FIG. 1 illustrates an exemplary method for mixed frequency valuation changes of illiquid assets;

FIG. 2 illustrates an exemplary method for mixed frequency valuation changes of illiquid assets where the illiquid assets include holdings in public and non-public companies;

FIG. 3 illustrates an exemplary method for valuing the holdings of a private equity company; and

FIG. 4 is a schematic of an exemplary computer-based system for a mixed frequency valuation system.

### DETAILED DESCRIPTION

In one embodiment of this invention, mixed frequency valuation changes, e.g., daily, weekly, biweekly, and/or monthly valuation changes, of illiquid assets, e.g., a portfolio company, real estate, or timber, are calculated. In one embodiment, a portfolio company is a corporate entity contained in a portfolio of private equity investments, held either directly or within a private equity fund. In certain embodiments, an illiquid asset is an asset which is not readily saleable due to uncertainty about its value or the lack of a market in which it is regularly traded. In one embodiment, an illiquid asset is an asset that has a future cash flow, but lacks daily market pricing. In certain embodiments, calculating mixed frequency valuation changes of illiquid assets is a function of two variables: (i) the price the market is willing to pay for the discounted sum of future earnings, and (ii) the amount of earnings that the firm produces over its lifetime. In one embodiment, mixed frequency valuation changes are calculated using models that separate the valuation changes into two components, a price component and an earnings component. In some embodiments, market returns capture the price component. In some embodiments, weekly aggregated macroeconomic factors capture the earnings component. In other embodiments, monthly aggregated macroeconomic factors capture the earnings component. In yet another embodiment, both weekly and monthly aggregated macroeconomic factors capture the earnings component. In some embodiments, one or both of unemployment insurance data and factory orders data capture the earnings component. In some embodiments, unemployment insurance data includes unemployment insurance claims data. In some embodiments, the unemployment insurance claims data is seasonally adjusted. In other embodiments, the unemployment insurance claims data is not seasonally adjusted. In some embodiments, factory orders data includes manufacturer's shipments, inventories, and orders data. In some embodiments, the manufacturer's shipments, inventories, and orders data is seasonally adjusted. In other embodiments, the manufacturer's shipments, inventories, and orders data is not seasonally adjusted. In some embodiments, lagged value changes are included in the model to capture the effect of lagged reporting in the private equity industry.

Private equity valuations are generally available on a quarterly basis. In certain embodiments, by relating quarterly valuation changes to higher frequency variables, e.g., market return data, unemployment insurance data, or factory orders data, valuation change estimates in-between reporting quarters are determined. In some embodiments, the valuation change estimates between reporting quarters are on a daily frequency. In other embodiments, the valuation change estimates between reporting quarters are on a weekly frequency. In other embodiments, the valuation change estimates between reporting quarters are on a monthly frequency. In one embodiment, panel regression methods are used to estimate the relationship between quarterly valuation changes and higher frequency variables, e.g., variables aggregate on a frequency higher than quarterly. In certain embodiments, reversing the estimated regression function allows daily valuation changes to be estimated in real time.

In one embodiment, estimating valuation changes of illiquid assets on a daily frequency is determined by scaling a change in the US Morgan Stanley Capital International Inc. (MSCI) Total Return Index (sector breakdown) and a lagged valuation change by estimated in-sample coefficients (base model). In some embodiments, as weekly data becomes available, the base model is extended by adding US unemployment insurance weekly claims as a regressor. In some embodiments, as monthly data becomes available, the base model is extending by adding both US unemployment insurance weekly claims and US factory orders as regressors.

In certain embodiments, the regression model design is selected on the basis of best in-sample fit and lowest out-of-sample root mean square deviation (RMSD). In one embodiment, the model specification for a daily equation is:

ΔVₜ=α+β₁MSCITRₜ+β₂ΔVₜ₋₁+εₜ, (1)

where ΔVₜ is the valuation change of a portfolio company at time t; α is a constant; β₁ is the coefficient of MSCITRₜ; MSCITRₜ is the US MSCI Total Return for the industry sector attributed to the portfolio company at time t; β₂ is the coefficient of ΔVₜ₋₁; ΔVₜ₋₁ is the valuation change of a portfolio company at a period immediately before time t; and εₜ is an error term.

In one embodiment, the model specification for a weekly equation is:

ΔVₜ=α+β₃MSCITRₜ+β₄ΔVₜ₋₁+β₅Unemploymentₜ+εₜ, (2)

where ΔK is the valuation change of a portfolio company at time t; α is a constant; β₃ is the coefficient of MSCITRₜ; MSCITRₜ is the US MSCI Total Return for the industry sector attributed to the portfolio company at time t; β₄ is the coefficient of ΔVₜ₋₁; ΔVₜ₋₁ is the valuation change of a portfolio company at a period immediately before time t; β₅ is the coefficient of Unemploymentₜ, Unemploymentₜ is the seasonally adjusted unemployment insurance claims at time t; and εₜ is an error term.

In one embodiment, the model specification for a monthly equation is:

ΔVₜ=α+β₆MSCITRₜ+β₇ΔV₁₋₁+β₈Unemploymentₜ+β₉Factoryordersₜ+εₜ, (3)

where ΔVₜ is the valuation change of a portfolio company at time t; α is a constant; β₆ is the coefficient of MSCITRₜ; MSCITRₜ is the US MSCI Total Return for the industry sector attributed to the portfolio company at time t; β₇ is the coefficient of ΔVₜ₋₁; ΔVₜ₋₁ is the valuation change of a portfolio company at a period immediately before time t; β₈ is the coefficient of Unemploymentₜ, Unemploymentₜ is the seasonally adjusted unemployment insurance claims at time t; is the coefficient of Factoryordersₜ, Factoryordersₜ is the seasonally adjusted data on manufacturer's shipments, inventors and orders at time t; and εₜ is an error term.

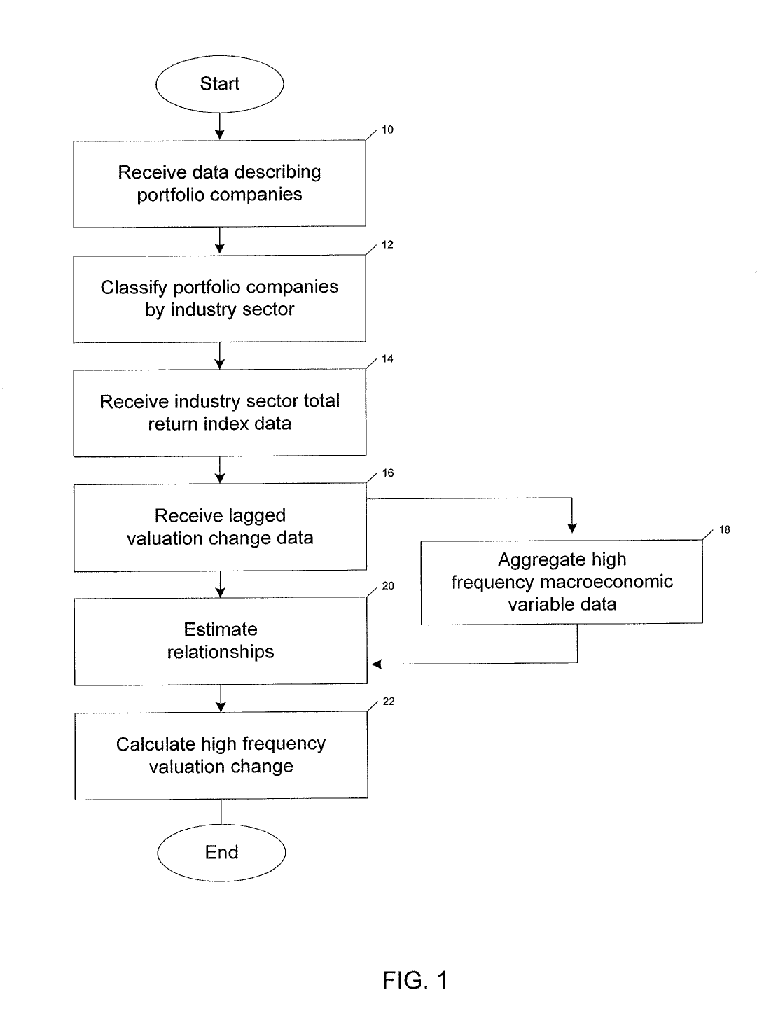

FIG. 1 shows an exemplary embodiment for calculating mixed frequency valuation changes of illiquid assets. In one embodiment, at step 10, data is received from a portfolio monitoring system describing a first group of portfolio companies (“first group”) and a second group portfolio companies (“second group”). In certain embodiments, the data received describing the first group and second group include one or more of portfolio company name, Global Industry Classification Standard (GICS) code, and net asset values. In certain embodiments, one or more of the portfolio companies in the first group are included in the portfolio companies in the second group. In other embodiments, one or more of the portfolio companies in the first group are not included in the portfolio companies of the second group.

Next, as shown in FIG. 1, at step 12, in certain embodiments, each portfolio company of one or both of the first group and second group are classified in accordance with the GICS. The GICS is an industry taxonomy developed by MSCI and Standard & Poor's (S&P) for use by the global financial community. In one embodiment, each portfolio company of one or both of the first group and second group are attributed to one of the following industry sector categories of the GICS: Energy, Materials, Industrials, Consumer Discretionary, Consumer Staples, Health Care, Financials, Information Technology, Telecommunications, or Utilities.

As shown in FIG. 1, at step 14, in certain embodiments, industry sector total return index data is received for each portfolio of one or both of the first group and second group. In one embodiment, the industry sector total return index data corresponds to each of the industry sector categories that were attributed to a portfolio company of one or both of the first group or second group. In certain embodiments, the industry sector total return index data is US MSCI Total Return Indices data categorized by industry sector. Different industry sectors are exposed to macroeconomic factors, which results in industry sector-dependent market returns. Hence, industry sector contingency has an implication for the change in mixed frequency (e.g., daily, weekly, and monthly) valuations of portfolio companies. In certain embodiments, the industry sector total return index data is the price component of the valuation model.

At step 16, as shown in FIG. 1, in certain embodiments, lagged valuation change data is received for each portfolio company of one or both of the first group and second group. Lagged valuation change data is added in certain embodiments at least because in some instances there is a lag effect in valuations due to private equity reporting practices.

At step 18, as shown in FIG. 1, in certain embodiments, one or more high frequency macroeconomic variables, e.g., macroeconomic variables aggregated higher than quarterly, are aggregated from one or more services or governmental agencies for each portfolio company of one or both of the first group and second group. In certain embodiments, step 18 is executed only when weekly valuation changes or monthly valuation changes are to be determined. In certain embodiments, the one or more high frequency macroeconomic variables include U.S. unemployment insurance data. In some embodiments, U.S. unemployment insurance data is seasonally adjusted unemployment insurance claims data. In one embodiment, the seasonally adjusted unemployment insurance claims data is received from the United States Department of Labor. In certain embodiments, U.S. unemployment insurance data is aggregated by the United Stated Department of Labor on a weekly basis. U.S. unemployment insurance data is added as a variable in certain embodiments at least because it is generally negatively correlated with the state of the economy. In certain embodiments, U.S. unemployment insurance data is part of the earnings component of the valuation model. In certain embodiments, the one or more high frequency macroeconomic variables include U.S. factory orders data. In one embodiment, U.S. factory orders data is seasonally adjusted data on manufacturer's shipments, inventors, and orders. In certain embodiments, the U.S. factory orders data is received from the United States Census Bureau. In certain embodiments, the U.S. factory orders data is aggregated by the United States Census Bureau on a monthly basis. U.S. factory orders data is added as a variable in certain embodiments at least because it is generally positively correlated with the state of the economy. In certain embodiments, U.S. factory orders data is part of the earnings component of the valuation model.

At step 20, as shown in FIG. 1, in some embodiments, the relationship between a valuation change and one or more of the received or aggregated data is estimated. In certain embodiments, estimating a relationship includes running a regression analysis.

In one embodiment, the relationship between a valuation change, the industry sector total return index data that corresponds to each of the industry sector categories that were attributed to a portfolio company of the first group, and the lagged valuation change data for each portfolio company of the first group are estimated. In certain embodiments, the estimated relationship will correspond to the following equation:

ΔVₜ=α+β₁MSCITRₜ+β₂ΔVₜ₋₁+εₜ, (1)

where ΔVₜ is the valuation change of a portfolio company at time t; α is a constant; β₁ is the coefficient of MSCITRₜ; MSCITRₜ is the US MSCI Total Return for the industry sector attributed to the portfolio company at time t; β₂ is the coefficient of ΔVₜ₋₁; ΔVₜ₋₁ is the valuation change of a portfolio company at a period immediately before time t; and Eₜ is an error term. In certain embodiments, at step 22, a daily valuation change is calculated for each portfolio company of the second group using the estimated relationship (1), the industry sector total return index data that corresponds to each of the industry sector categories that were attributed to a portfolio company of the second group, and the lagged valuation change data for each portfolio company of the second group.

In one embodiment, the relationship between a valuation change, the industry sector total return index data that corresponds to each of the industry sector categories that were attributed to a portfolio company of the first group, the lagged valuation change data for each portfolio company of the first group, and the U.S. employment insurance data are estimated. In certain embodiments, the estimated relationship will correspond to the following equation:

ΔVₜ=α+β₃MSCITRₜ+β₄ΔVₜ₋₁+β₅Unemploymentₜ+εₜ, (2)

where ΔVₜ is the valuation change of a portfolio company at time t; α is a constant; β₃ is the coefficient of MSCITRₜ; MSCITRₜ is the US MSCI Total Return for the industry sector attributed to the portfolio company at time t; β₄ is the coefficient of ΔVₜ₋₁; ΔVₜ₋₁ is the valuation change of a portfolio company at a period immediately before time t; β₅ is the coefficient of Unemploymentₜ, Unemploymentₜ is the seasonally adjusted unemployment insurance claims at time t; and εₜ is an error term. In certain embodiments, at step 22, a weekly valuation change is calculated for each portfolio company of the second group using the estimated relationship (2), the industry sector total return index data that corresponds to each of the industry sector categories that were attributed to a portfolio company of the second group, the lagged valuation change data for each portfolio company of the second group, and the U.S. employment insurance data.

In one embodiment, the relationship between a valuation change, the industry sector total return index data that corresponds to each of the industry sector categories that were attributed to a portfolio company of the first group, the lagged valuation change data for each portfolio company of the first group, and the U.S. employment insurance data are estimated. In certain embodiments, the estimated relationship will correspond to the following equation:

ΔVₜ=α+β₆MSCITRₜ+β₇ΔV₁₋₁+β₈Unemploymentₜ+β₉Factoryordersₜ+εₜ, (3)

where ΔVₜ is the valuation change of a portfolio company at time t; α is a constant; β₆ is the coefficient of MSCITRₜ; MSCITRₜ is the US MSCI Total Return for the industry sector attributed to the portfolio company at time t; β₇ is the coefficient of ΔVₜ₋₁; ΔVₜ₋₁ is the valuation change of a portfolio company at a period immediately before time t; β₈ is the coefficient of Unemploymentₜ, Unemploymentₜ is the seasonally adjusted unemployment insurance claims at time t; β₉ is the coefficient of Factoryordersₜ, Factoryordersₜ is the seasonally adjusted data on manufacturer's shipments, inventors and orders at time t; and sₜ is an error term. In certain embodiments, at step 22, a monthly valuation change is calculated for each portfolio company of the second group using the estimated relationship (3), the industry sector total return index data that corresponds to each of the industry sector categories that were attributed to a portfolio company of the second group, the lagged valuation change data for each portfolio company of the second group, the U.S. employment insurance data, and the U.S. factory orders data.

In certain embodiments, each portfolio company of the second group is a non-public company. In certain embodiments, the second group of portfolio companies includes both public companies and non-public companies.

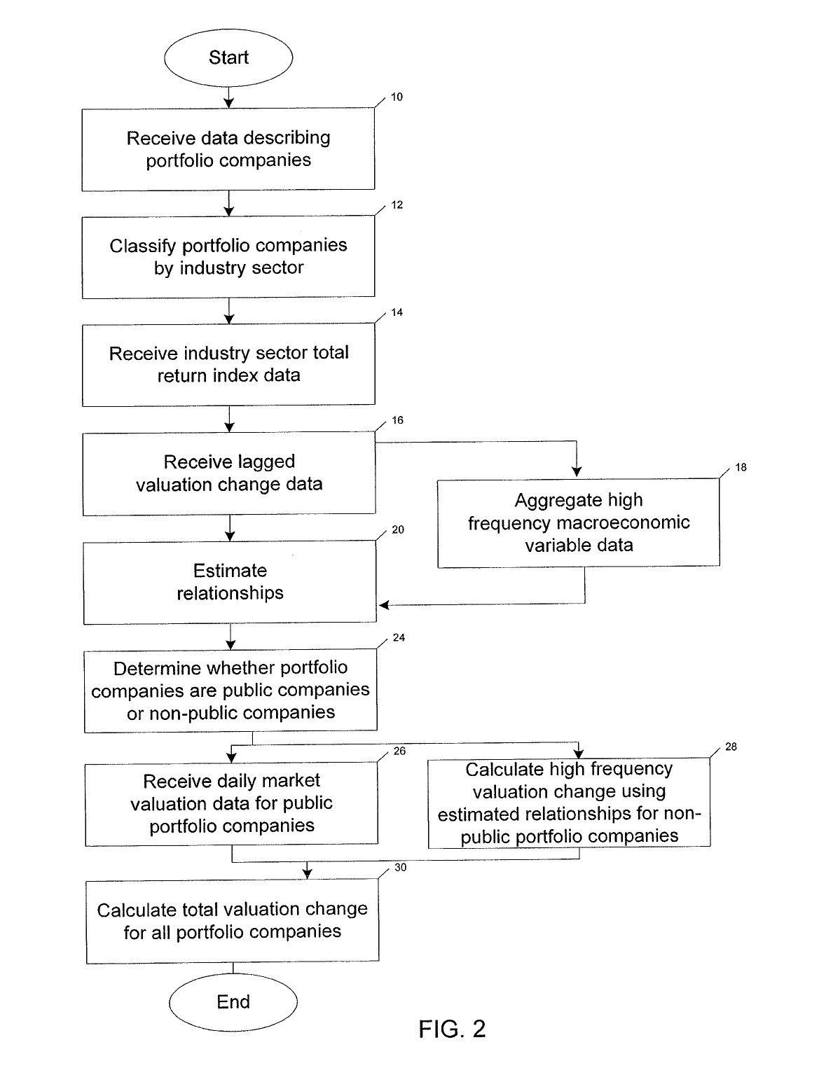

As shown in FIG. 2, in some embodiments, where the second group includes public companies and non-public companies, a determination is made at step 24 which portfolio companies of the second group are public companies and non-public companies. In certain embodiments, at step 26, daily market valuation data is received for each publicly listed portfolio company. Daily market valuation data may be received from one or more vendors that provide prices for publicly listed companies, e.g., Bloomberg L.P. In some embodiments, at step 28, total valuation changes for the non-public companies are calculated in the manner described above. In some embodiments, at step 30, the total valuation change for the second group (both public companies and non-public companies) is calculated using the daily market valuation data for each publicly listed portfolio company and the valuation change for each non-publicly listed portfolio company.

In certain embodiments, valuations of portfolio companies are determined rather than valuation changes of portfolio companies. One of ordinary skill in the art would appreciate how valuations of portfolio companies would be determined by using the systems and methods disclosed herein.

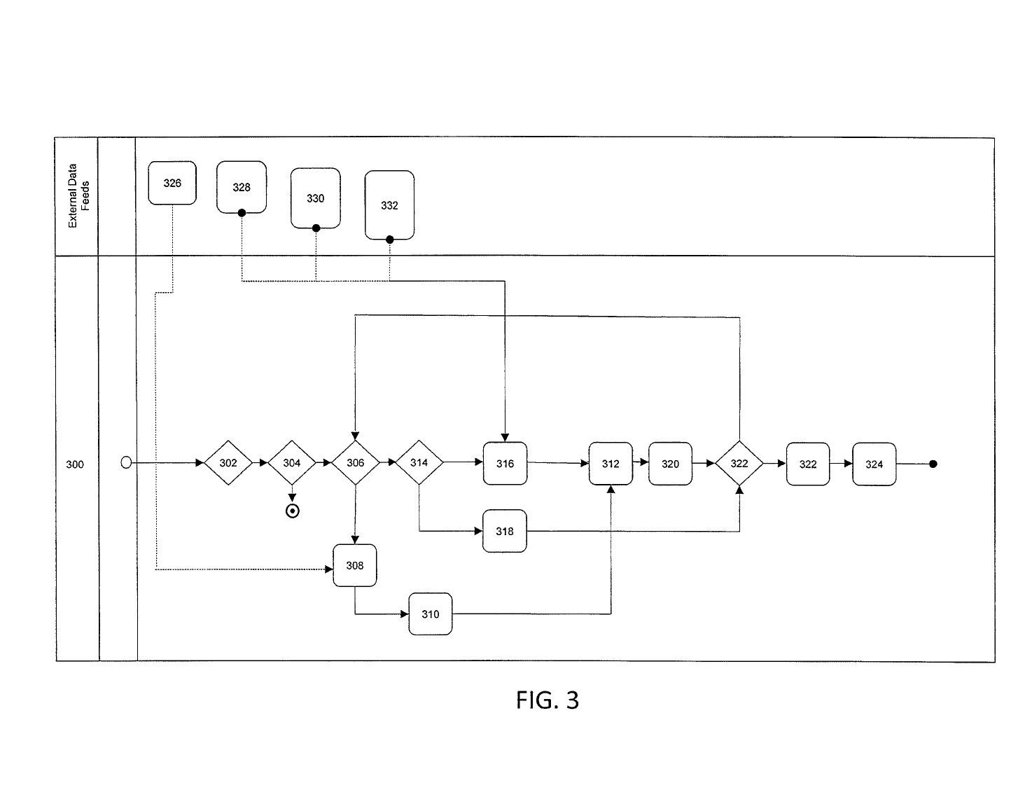

FIG. 3 illustrates an exemplary method for valuing the holdings of a private equity company. In one embodiment, the holdings include financial investments by the private equity company in one or more portfolio companies. In one embodiment, computer system 300 is specially programmed to perform all of the described functionality referenced in relation to FIG. 3. In one embodiment, computer system 300 is a specially programmed computer that determines mixed frequency valuations and valuation changes, e.g., daily, weekly, biweekly, and/or monthly valuations and valuation changes, of illiquid assets, e.g., portfolio companies. Existing, generic computer systems do not operate and are not programmed in this manner. Further, processors within computer system 300 are specially programmed to perform the processes described herein. At step 302, computer system 300 checks for confirmation of reconciliation completion. In one embodiment, reconciliation is the process by which computer system 300 ensures that cash flow movements in respect of each investment have been completely and accurately captured. Where reconciliation completion is not confirmed, step 302 will repeat until computer system 300 confirms reconciliation completion. Upon confirmation of reconciliation completion, computer system 300 proceeds to analyze, in turn, each company identified as a being a portfolio company in which the private equity company has financially invested.

At step 304, computer system 300 confirms whether the private equity company owns an interest in the portfolio company. In one embodiment, computer system 300 maintains a list of all companies in which the private equity company has investments. In one embodiment, computer system 300 analyzes the maintained list of companies to confirm whether the private equity company owns an interest in a portfolio company. For each company where it is determined that the private equity company no longer owns an interest, computer system 300 will discontinue further analysis of such company. For each company where it is determined that the private equity company owns an interest, computer system will continue its analysis and, at step 306, computer system 300 determines whether said portfolio company is a publicly listed company.

If a portfolio company is identified as a publicly listed company, at step 308, computer system 300 requests and receives daily market price data from a financial source 326, e.g., Bloomberg, for that publicly listed company. In one embodiment, the daily market price data includes the net asset value of the publicly listed company. In other embodiments, the daily market price data includes the change in net asset value of the publicly listed company. In certain embodiments, computer system 300 can convert the daily market price data from a first currency to a second currency. In certain embodiments, at step 310, if the daily price data is in a first currency, e.g, EUR, the system converts it to a second currency, e.g., U.S. dollars. In one embodiment, the second currency is a pre-set, default currency in which calculations must be made in computer system 300. In certain embodiments, once the daily market price data is converted to the second currency, computer system 300 updates the net asset value or change in net asset value of each publicly listed company at step 312.

If a portfolio company is identified as a non-publicly listed company, at step 314, computer system 300 determines whether to apply a valuation equation (e.g., a daily equation, weekly equation, or monthly equation) to determine the net asset value or change in net asset value of the non-publicly listed company. In one embodiment, non publicly listed companies will be selected for the valuation equation where the date of the last valuation received is before the current valuation date, an investment in the non publicly listed company has not been completely sold or otherwise disposed of, the earnings before interest, taxes, depreciation, and amortization (“EBITDA”) for the non-publicly listed company is greater than $1,000,000 and the non-publicly listed company's valuation is not equal to the book cost of that company. If a valuation equation is to be applied, at step 316, computer system 300 determines which of a daily equation, weekly equation, or monthly equation to apply to determine the non-publicly listed company's net asset value or change in net asset value and applies such equation. In certain embodiments, the application of the valuation equations will include receiving data from one or more of external data feed 328, which transmits data relating to US MSCI Total Return for the industry sector attributed to the portfolio company, external data feed 330, which transmits data relating to seasonally adjusted unemployment insurance claims, and external data feed 332, which transmits data relating to seasonally adjusted data on manufacturer's shipments, inventors and orders. Once the daily market price data is calculated, computer system 300 updates the net asset value or change in net asset value of each non-publicly listed company at step 312.

If, at step 314, it is determined a valuation equation should not be applied to determine the non-publicly listed company's net asset value or change in net asset value, the previous net asset value or change in net asset value for said non-publicly listed company computer system 300 has on record is retrieved at step 318. Once the previous net asset value or change in net asset value for said non-publicly listed company is retrieved, computer system 300 uses said values to update the net asset value or change in net asset value of the non-publicly listed company at step 312.

At step 320, the net asset value or change in net asset value of each analyze portfolio company is aggregated to determine the net asset value or change in net asset value of the private equity company's holdings. At step 322, computer system 300 determines whether net asset values or change in net asset values have been calculated for each portfolio company. If each company has not been analyzed, computer system 300 returns to step 306 and repeats the process steps with a different company. The process will repeat until the net asset values or change in net asset values of all of the portfolio companies have been calculated.

At step 324, computer system 300 calculates the percentage investment the private equity company has in each portfolio company to determine the net asset value or change in net asset value of the private equity's holdings.

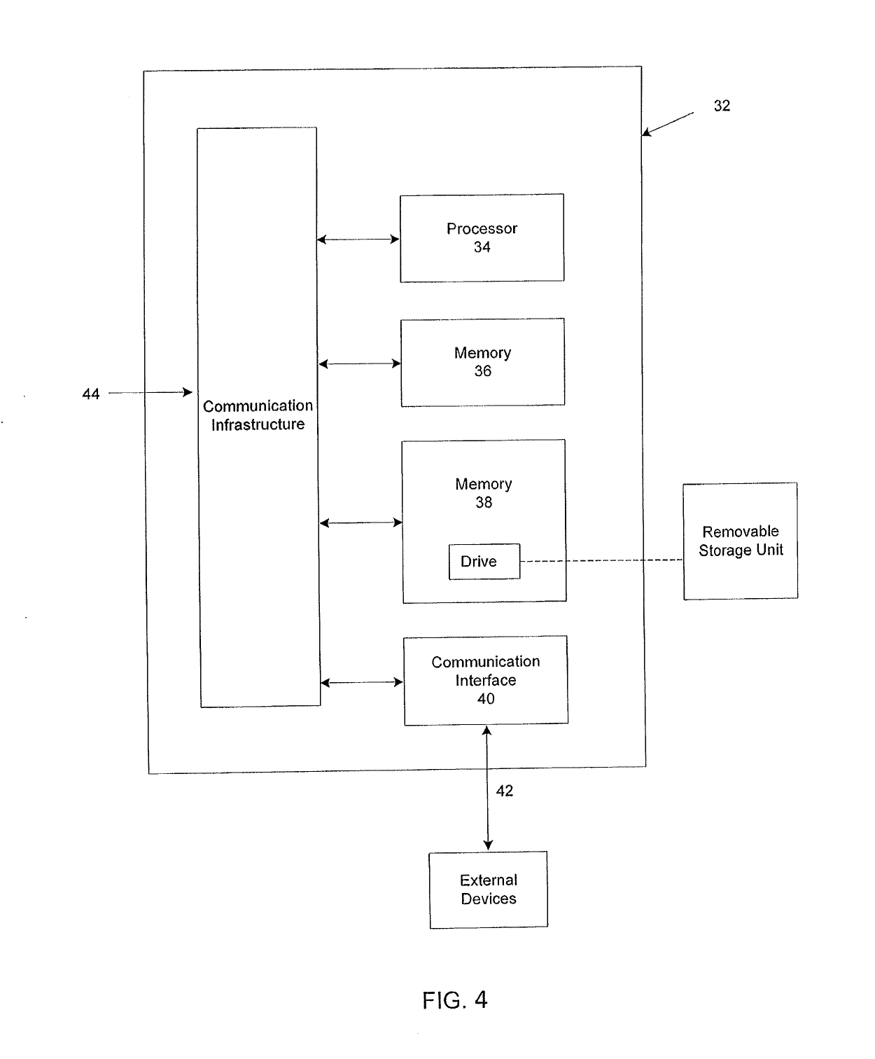

An exemplary computer system, including computer hardware, that may be used to implement the methods of the present invention is now described with reference to FIG. 4. One skilled in the art will recognize that the described architecture is exemplary only and variations on the system described below can be used within the scope of the present invention.

In certain embodiments, computer system 42 comprises hardware, as described more fully herein, that is used in connection with executing software/computer programming code (i.e., computer readable instructions) to carry out the steps of the methods described herein.

In certain embodiments, computer system 42 includes one or more processors 44. Processor 44 may be any type of processor, including but not limited to a special purpose or a general-purpose digital signal processor. In certain embodiments, processor 44 is connected to a communication infrastructure 54 (for example, a bus or network). In certain embodiments, processors 44 are specially programmed to perform the processes described herein, including estimating relationships between higher frequency variables and calculating a valuation or a change in valuation for a portfolio company. Various software implementations are described in terms of this exemplary computer system. After reading this description, it will become apparent to a person skilled in the art how to implement the invention using other computer systems and/or computer architectures.

In some embodiments, computer system 42 includes one or more memories 46, 48. In some embodiments, memory 46 is random access memory (RAM). In some embodiments, memory 48 includes, for example, a hard disk drive and/or a removable storage drive, such as a floppy disk drive, a magnetic tape drive, or an optical disk drive, by way of example. Removable storage drive reads from and/or writes to a removable storage unit (e.g., a floppy disk, magnetic tape, optical disk, by way of example) as will be known to those skilled in the art. As will be understood by those skilled in the art, removable storage unit includes a computer usable storage medium having stored therein computer software and/or data.

In certain embodiments, memory 48 may include other similar means for allowing computer programs or other instructions to be loaded into computer system 42. Such means may include, for example, a removable storage unit and an interface. Examples of such means may include a removable memory chip (such as an EPROM, or PROM, or flash memory) and associated socket, and other removable storage units and interfaces which allow software and data to be transferred from removable storage unit to computer system 42. Alternatively, the program may be executed and/or the data accessed from the removable storage unit, using the processor 44 of the computer system 42.

In some embodiments, computer system 42 may also include a communication interface 50. In certain embodiments, communication interface 50 allows software and data to be transferred between computer system 42 and external devices. Examples of communication interface 50 include a modem, a network interface (such as an Ethernet card), and a communication port, by way of example. In some embodiments, software and data transferred via communication interface 50 are in the form of signals, which may be electronic, electromagnetic, optical, or other signals capable of being received by communication interface 50. In certain embodiments, these signals are provided to communication interface 50 via a communication path 52. In some embodiments, communication path 52 carries signals and may be implemented using wire or cable, fiber optics, a phone line, a wireless link, a cellular phone link, a radio frequency link, or any other suitable communication channel, including a combination of the foregoing exemplary channels.

The terms “non-transitory computer readable medium”, “computer program medium” and “computer usable medium” are used generally to refer to media such as removable storage drive, a hard disk installed in hard disk drive, and non-transitory signals, as described herein. These computer program products are means for providing software to computer system 42. However, these terms may also include signals (such as electrical, optical or electromagnetic signals) that embody the computer program disclosed herein.

In certain embodiments, computer programs are stored in memory 46 and/or memory 48. In some embodiments, computer programs may also be received via communication interface 50. In some embodiments, such computer programs, when executed, enable computer system 42 to implement the present invention as discussed herein. Accordingly, in some embodiments, such computer programs represent controllers of computer system 42. In some embodiments, where the invention is implemented using software, the software is stored in a computer program product and loaded into computer system 42 using removable storage drive, hard disk drive, or communication interface 50, to provide some examples.

The computers referenced herein are specially programmed to perform the functionality described herein and, thus, are not generic computers. It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

1. A system comprising:
memory operable to store at least one program;
at least one processor communicatively coupled to the memory, in which the at least one program, when executed by the at least one processor, causes the at least one processor to:
receive data describing a first group of one or more portfolio companies and a second group of one or more portfolio companies;
attribute an industry sector classification to each portfolio company of the first group of one or more portfolio companies and to each portfolio company of the second group of one or more portfolio companies;
receive industry sector total return index data for the industry sector classifications attributed to each portfolio company of the first group of one or more portfolio companies and to each portfolio company of the second group of one or more portfolio companies;
receive lagged valuation change data for each portfolio company of the first group of one or more portfolio companies and for each portfolio company of the second group of one or more portfolio companies;
estimate the relationship between a valuation change, the industry sector total return index data for the industry sector classifications attributed to each portfolio company of the first group of one or more portfolio companies and the lagged valuation change data for each portfolio company of the first group of one or more portfolio companies; and
calculate a daily valuation change for each portfolio company of the second group of one or more portfolio companies using the estimated relationship between the valuation change, the industry sector total return index data for the industry sector classifications attributed to each portfolio company of the first group of one or more portfolio companies and the lagged valuation change data for each portfolio company of the first group of one or more portfolio companies.

2. The system of claim 1, further configured to:
aggregate one or more high frequency macroeconomic variables for each portfolio company of the first group of one or more portfolio companies and for each portfolio company of the second group of one or more portfolio companies;
estimate the relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies; and
calculate one or more high-frequency valuation changes for each portfolio company of the second group of one or more portfolio companies using the estimated relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies.

3. The system of claim 2, wherein the one or more high frequency macroeconomic variables includes U.S. unemployment insurance.

4. The system of claim 3, wherein the one or more high-frequency valuation changes include a weekly valuation change.

5. The system of claim 2, wherein the one or more high frequency macroeconomic variables includes U.S. unemployment insurance and U.S. factory orders.

6. The system of claim 5, wherein the one or more high-frequency valuation changes include a monthly valuation change.

7. The system of claim 5, wherein the one or more high-frequency valuation changes include a weekly valuation change and a monthly valuation change.

8. A system comprising:
memory operable to store at least one program;
at least one processor communicatively coupled to the memory, in which the at least one program, when executed by the at least one processor, causes the at least one processor to:
receive data describing a first group of one or more portfolio companies and a second group of one or more portfolio companies;
attribute industry sector classifications to each portfolio company of the first group of one or more portfolio companies;
receive industry sector total return index data for the industry sector classifications attributed to each portfolio company of the first group of one or more portfolio companies;
receive lagged valuation change data for each portfolio company of the first group of one or more portfolio companies;
estimate the relationship between a valuation change, the industry sector total return index data for the industry sector classifications attributed to each portfolio company of the first group of one or more portfolio companies and the lagged valuation change data for each portfolio company of the first group of one or more portfolio companies;
for each portfolio company of the second group of one or more portfolio companies, determine whether each portfolio company of the second group of one or more portfolio companies is a publicly listed portfolio company or a non-publicly listed portfolio company;
receive daily market valuation change data for each publicly listed portfolio company;
for each non-publicly listed company:
receive industry sector classifications attributed to each non-publicly listed company;
receive industry sector total return index data for each non-publicly listed company;
receive lagged valuation change data for each non-publicly listed company; and
for each non-publicly listed company, calculate a daily valuation change for each non-publicly listed company using the estimated relationship between the valuation change, the industry sector total return index data for the industry sector classifications attributed to each portfolio company of the first group of one or more portfolio companies and the lagged valuation change data for each portfolio company of the first group of one or more portfolio companies; and
calculate a total valuation change for the second group of one or more portfolio companies using the daily market valuation change data for each publicly listed portfolio company and the daily valuation change for each non-publicly listed company.

9. A non-transitory computer readable storage medium having stored thereon computer executable instructions which, when executed on a computer, configure the computer to perform a method comprising:
receiving data describing a first group of one or more portfolio companies and a second group of one or more portfolio companies;
attributing industry sector classifications to each portfolio company of the first group of one or more portfolio companies and to each portfolio company of the second group of one or more portfolio companies;
receiving industry sector total return index data for the industry sector classifications attributed to each portfolio company of the first group of one or more portfolio companies and to each portfolio company of the second group of one or more portfolio companies;
receiving lagged valuation change data for each portfolio company of the first group of one or more portfolio companies and for each portfolio company of the second group of one or more portfolio companies;
estimating the relationship between a valuation change, the industry sector total return index data for the industry sector classifications attributed to each portfolio company of the first group of one or more portfolio companies and the lagged valuation change data for each portfolio company of the first group of one or more portfolio companies; and
calculating a daily valuation change for each portfolio company of the second group of one or more portfolio companies using the estimated relationship between the valuation change, the industry sector total return index data for the industry sector classifications attributed to each portfolio company of the first group of one or more portfolio companies and the lagged valuation change data for each portfolio company of the first group of one or more portfolio companies.

10. The non-transitory computer readable storage medium of claim 9, further comprising:
aggregating one or more high frequency macroeconomic variables for each portfolio company of the first group of one or more portfolio companies and for each portfolio company of the second group of one or more portfolio companies;
estimating the relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies; and
calculating one or more high-frequency valuation changes for each portfolio company of the second group of one or more portfolio companies using the estimated relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies.

11. The non-transitory computer readable storage medium of claim 10, wherein the one or more high frequency macroeconomic variables includes U.S. unemployment insurance.

12. The non-transitory computer readable storage medium of claim 11, wherein the one or more high-frequency valuation changes include a weekly valuation change.

13. The non-transitory computer readable storage medium of claim 10, wherein the one or more high frequency macroeconomic variables includes U.S. unemployment insurance and U.S. factory orders.

14. The non-transitory computer readable storage medium of claim 13, wherein the one or more high-frequency valuation changes include a monthly valuation change.

15. The non-transitory computer readable storage medium of claim 13, wherein the one or more high-frequency valuation changes include a weekly valuation change and a monthly valuation change.

16. A non-transitory computer readable storage medium having stored thereon computer executable instructions which, when executed on a computer, configure the computer to perform a method comprising:
receiving data describing a first group of one or more portfolio companies and a second group of one or more portfolio companies;
attributing industry sector classifications to each portfolio company of the first group of one or more portfolio companies;
receiving industry sector total return index data for the industry sector classifications attributed to each portfolio company of the first group of one or more portfolio companies;
receiving lagged valuation change data for each portfolio company of the first group of one or more portfolio companies;
estimating the relationship between a valuation change, the industry sector total return index data for the industry sector classifications attributed to each portfolio company of the first group of one or more portfolio companies and the lagged valuation change data for each portfolio company of the first group of one or more portfolio companies;
for each portfolio company of the second group of one or more portfolio companies, determining whether each portfolio company of the second group of one or more portfolio companies is a publicly listed portfolio company or a non-publicly listed portfolio company;
receiving daily market valuation change data for each publicly listed portfolio company;
for each non-publicly listed company:
attributing industry sector classifications to each non-publicly listed company;
receiving industry sector total return index data for each non-publicly listed company;
receiving lagged valuation change data for each non-publicly listed company; and
for each non-publicly listed company, calculating a daily valuation change for each non-publicly listed company using the estimated relationship between the valuation change, the industry sector total return index data for the industry sector classifications attributed to each portfolio company of the first group of one or more portfolio companies and the lagged valuation change data for each portfolio company of the first group of one or more portfolio companies; and
calculating a total valuation change for the second group of one or more portfolio companies using the daily market valuation change data for each publicly listed portfolio company and the daily valuation change for each non-publicly listed company.

17. A computer implemented method comprising:
receiving data describing a first group of one or more portfolio companies and a second group of one or more portfolio companies;
attributing industry sector classifications to each portfolio company of the first group of one or more portfolio companies and to each portfolio company of the second group of one or more portfolio companies;
receiving industry sector total return index data for the industry sector classifications attributed to each portfolio company of the first group of one or more portfolio companies and to each portfolio company of the second group of one or more portfolio companies;
receiving lagged valuation change data for each portfolio company of the first group of one or more portfolio companies and for each portfolio company of the second group of one or more portfolio companies;
estimating the relationship between a valuation change, the industry sector total return index data for the industry sector classifications attributed to each portfolio company of the first group of one or more portfolio companies and the lagged valuation change data for each portfolio company of the first group of one or more portfolio companies; and
calculating a daily valuation change for each portfolio company of the second group of one or more portfolio companies using the estimated relationship between the valuation change, the industry sector total return index data for the industry sector classifications attributed to each portfolio company of the first group of one or more portfolio companies and the lagged valuation change data for each portfolio company of the first group of one or more portfolio companies.

18. The computer implemented method of claim 17, further comprising:
aggregating one or more high frequency macroeconomic variables for each portfolio company of the first group of one or more portfolio companies and for each portfolio company of the second group of one or more portfolio companies;
estimating the relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies; and
calculating one or more high-frequency valuation changes for each portfolio company of the second group of one or more portfolio companies using the estimated relationship between the valuation change, the industry sector total return index data for the industry sector classifications attributed to each portfolio company of the first group of one or more portfolio companies, the lagged valuation change data for each portfolio company of the first group of one or more portfolio companies, and the aggregated one or more high frequency macroeconomic variables for each portfolio company of the first group of one or more portfolio companies.

19. A computer implemented method comprising:
receiving data describing a first group of one or more portfolio companies and a second group of one or more portfolio companies;
attributing industry sector classifications to each portfolio company of the first group of one or more portfolio companies;
receiving industry sector total return index data for the industry sector classifications attributed to each portfolio company of the first group of one or more portfolio companies;
receiving lagged valuation change data for each portfolio company of the first group of one or more portfolio companies;
estimating the relationship between a valuation change, the industry sector total return index data for the industry sector classifications attributed to each portfolio company of the first group of one or more portfolio companies and the lagged valuation change data for each portfolio company of the first group of one or more portfolio companies;
for each portfolio company of the second group of one or more portfolio companies, determining whether each portfolio company of the second group of one or more portfolio companies is a publicly listed portfolio company or a non-publicly listed portfolio company;
receiving daily market valuation change data for each publicly listed portfolio company;
for each non-publicly listed company:
attributing industry sector classifications to each non-publicly listed company;
receiving industry sector total return index data for each non-publicly listed company;
receiving lagged valuation change data for each non-publicly listed company; and
for each non-publicly listed company, calculating a daily valuation change for each non-publicly listed company using the estimated relationship between the valuation change, the industry sector total return index data for the industry sector classifications attributed to each portfolio company of the first group of one or more portfolio companies and the lagged valuation change data for each portfolio company of the first group of one or more portfolio companies; and
calculating a total valuation change for the second group of one or more portfolio companies using the daily market valuation change data for each publicly listed portfolio company and the daily valuation change for each non-publicly listed company.
